(19) United States
(12) Patent Application Publication
(10) Pub. No.: US 2023/0286005 A1
(43) Pub. Date: Sep. 14, 2023

(54) DISPENSING DEVICE FOR MULTIPHASE LIQUIDS

(71) Applicants: Barbara APPERTI, Monza (IT); Paolo MAPELLI, Monza (IT)

(72) Inventors: Barbara APPERTI, Monza (IT); Paolo MAPELLI, Monza (IT)

(21) Appl. No.: 18/000,593

(22) PCT Filed: May 31, 2021
(86) PCT No.: PCT/IB2021/054759

§ 371 Date: Dec. 2, 2022

(30) Foreign Application Priority Data
Jun. 3, 2020 (IT) 102020000013123

(51) Int. Cl. B05B 15/30; B05B 11/00

(52) U.S. Cl. CPC B05B 15/30; B05B 11/0078

(57) ABSTRACT

A dispensing device for multiphase liquids, including a closed casing defining a chamber to contain one or more substances, a multiphase liquid including first and second components within the chamber, of different and immiscible density, within the chamber to form, at least when the multiphase liquid is at rest, an interface surface delimiting phasic components, a dispenser including a cannula defining a first extension direction skewed relative to the ground when the device is in use to access the multiphase liquid, and an expulsion mechanism on the top of the casing, operatively connected to the cannula to pump the multiphase liquid from the chamber outwards, the cannula has a plurality of first accesses arranged on planes spaced along the first direction of extension so at least two first accesses are separated from the interface surface and the expulsion mechanism simultaneously pumps the first and second components.

The present invention relates to a dispensing device for multiphase liquids of the type specified in the preamble of the first claim.

In particular, the present invention relates to a dispensing device for liquids which comprise a plurality of phases, preferably two phases, provided with a containment tank and a dispenser.

The substances, for example in the liquid state, multiphase are currently known. Multiphase liquids are basically made up of a heterogeneous mixture of two or more components that form at least two phases. If there are two phases, in particular, it is meant of a biphasic substance.

The phases involved in the multiphase substance can have the same or different state of aggregation. Unlike homogeneous mixtures, in two-phase substances there is always the presence of a separation interface between the at least two phases. In the case of multiphase liquid substances, in particular, the phase components consist of liquids that are immiscible to each other.

Among the devices for dispensing multiphase substances in the liquid state, for example, the Sheridan™ branded double tank bottle is known.

Said bottle substantially comprises two immiscible liquids arranged, each one, within its own tank, or its own chamber. Furthermore, the container includes a dispenser configured to mix the two liquids when dispensing is performed.

Of course, the liquids in question are food-grade.

However, there are also other types of multiphase liquids, preferably biphasic, in the field of cosmetics.

In order to allow the simultaneous dispensing and mixing of the phases, devices have been made as described, for example, in patent applications GB-A-1180427, U.S. Pat. No. 3,760,986, WO-A-0126821 and WO-A-2010133209.

The dispensing devices for cosmetics described in the aforementioned applications also include a tank dedicated to each phasic component and a dispenser configured to mix the components when operated.

Therefore, in order to contain and dispense the multiphase liquids, the devices of the known art seem to teach to use separate tanks for each component and to mix the components exclusively during the dispensing phase.

Alternatively, there are two-phase cosmetics that include the phasic components within the same bottle.

However, before using the liquid, it is generally necessary to manually mix the contents of the bottle to mix the different phases included therein.

Therefore, the known art described includes some important drawbacks.

In particular, according to the known teachings, in order to be able to use a multiphase liquid it is necessary to provide a multi-chamber container in which the chambers are individually connected to a common dispenser. Therefore, the container results to be rather complex and, probably, not very economical. The alternative configuration described, on the other hand, has the important drawback of forcing the user to manually mix the bottle, for example by repeatedly shaking it.

In this situation, the technical task underlying the present invention is to devise a dispensing device for multiphase liquids capable of substantially obviating at least part of the aforementioned drawbacks.

Within the scope of said technical task, it is an important object of the invention to obtain a multiphase dispensing device for liquids which is structurally simpler and less complex than the devices of the prior art.

Another important object of the invention is to provide a dispensing device for multiphase liquids which allows mixing of the phase components without resorting to manual mixing by a user.

In conclusion, a further aim of the invention is to provide a dispensing device for multiphase liquids which allows the phasic components to be mixed in an effective and performing manner for the purposes indicated above.

The technical task and the specified aims are achieved by a dispensing device for multiphase liquids as claimed in the attached claim 1.

Preferred technical solutions are highlighted in the dependent claims.

The characteristics and advantages of the invention are clarified below by the detailed description of preferred embodiments of the invention, with reference to the accompanying figures, in which:

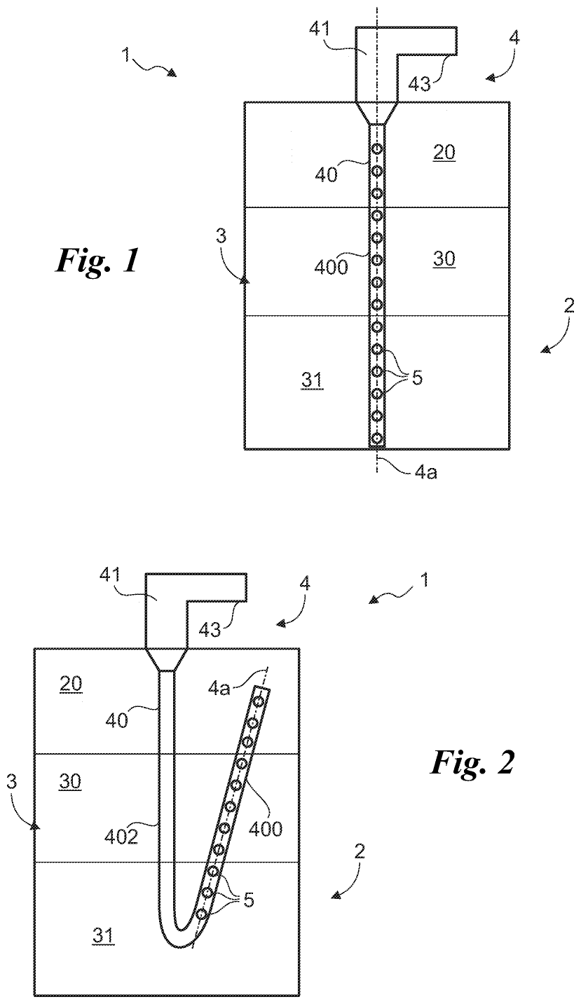

the FIG. 1 shows a simplified diagram of a dispensing device for multiphase liquids according to the invention in a first embodiment;

the FIG. 2 illustrates a simplified diagram of a dispensing device for multiphase liquids according to the invention in a second embodiment wherein the first section is connected to the expulsion mechanism by means of a connecting part and the cannula defines U-shape;

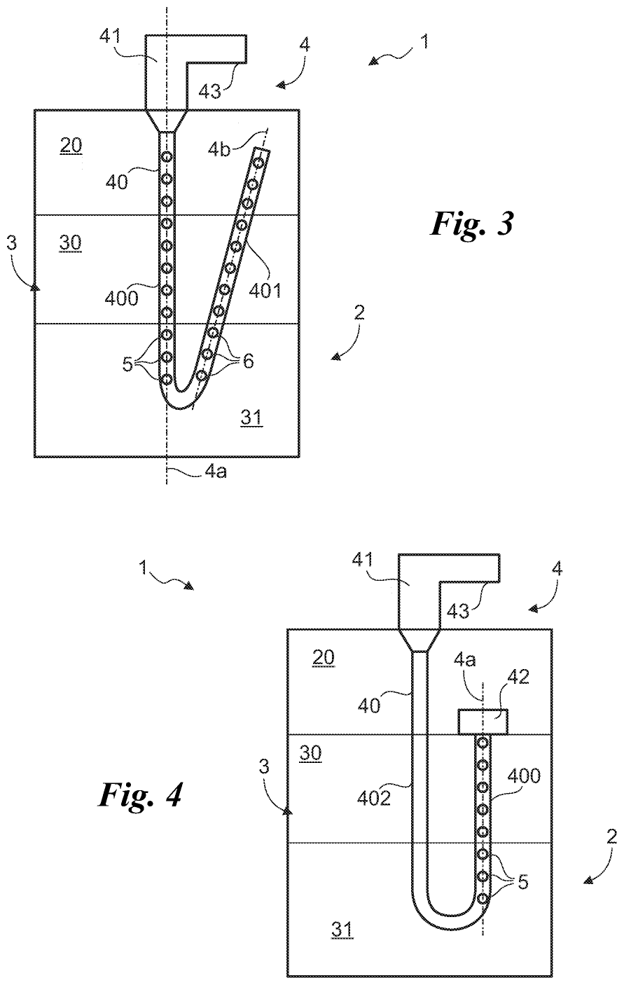

the FIG. 3 is a simplified diagram of a dispensing device for multiphase liquids according to the invention in a third embodiment in which the cannula includes both a first, and a second portion and defines U-shape;

the FIG. 4 shows a simplified diagram of a dispensing device for multiphase liquids according to the invention in a second alternative embodiment wherein the free end of the first section is maintained on the free surface of the liquid multiphase by a float;

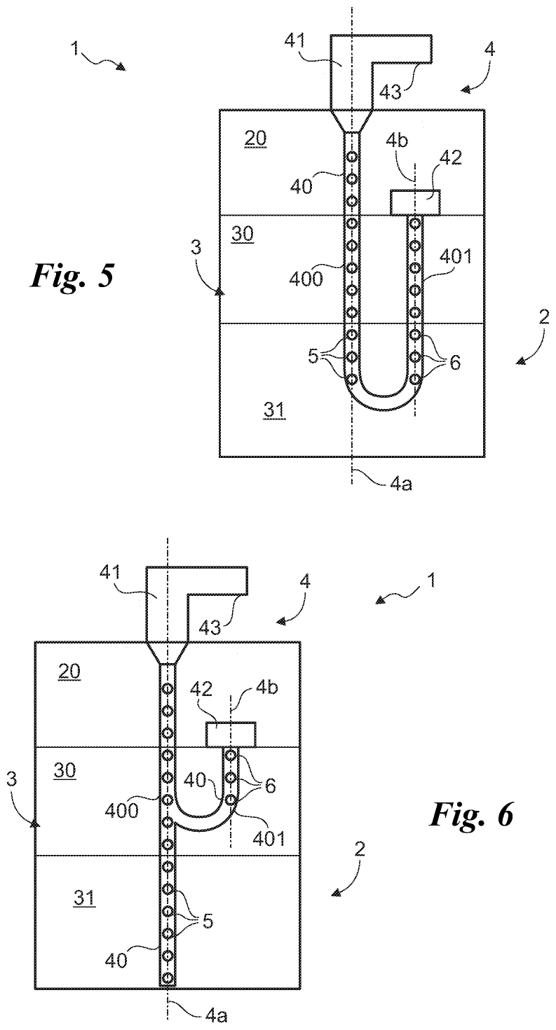

the FIG. 5 shows a simplified diagram of a dispensing device according to the invention for multiphase liquids in a third alternative embodiment in which the free end of the second portion is maintained on the free surface of the multiphase fluid by a float;

the FIG. 6 illustrates a simplified diagram of a dispensing device for multiphase liquids according the invention in a fourth alternative embodiment comprising two cannulas that share a first section and wherein a cannula is realized according the first embodiment of FIG. 1 and the other cannula is made according to the third alternative embodiment of FIG. 5;

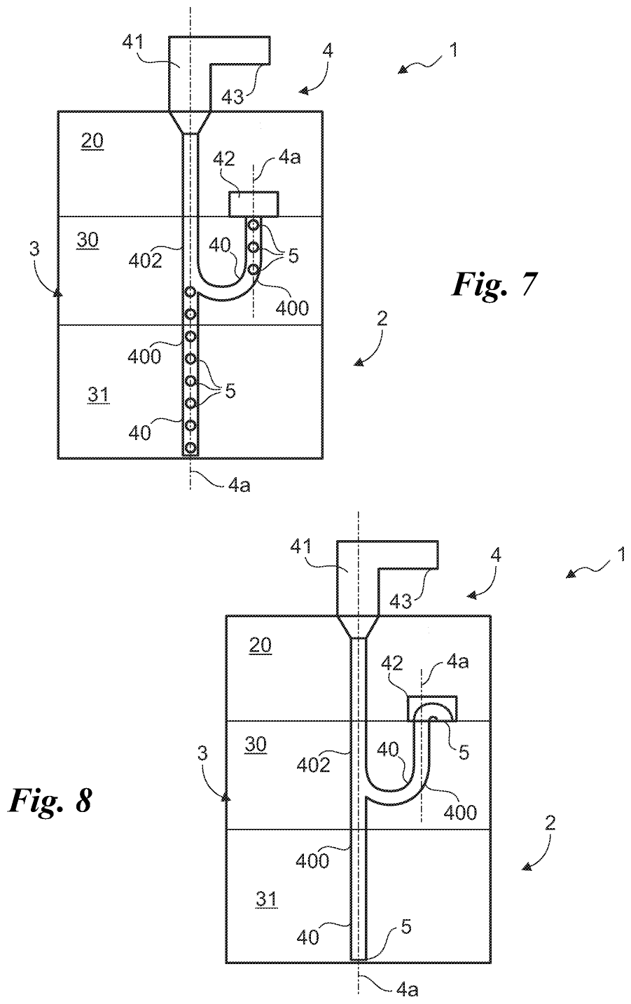

the FIG. 7 is a simplified diagram of a dispensing device for multiphase liquids according to the invention in a fourth embodiment comprising two cannulas that share a connecting part and wherein a cannula is made according to the first embodiment of FIG. 1 and the other cannula is made according to the second alternative embodiment of FIG. 4;

the FIG. 8 represents a simplified diagram of a dispensing device for multiphase liquids according to the invention in a fifth embodiment comprising two cannulas that share a connecting part, or a bifurcated cannula, wherein each end of the cannula reaches a respective component;

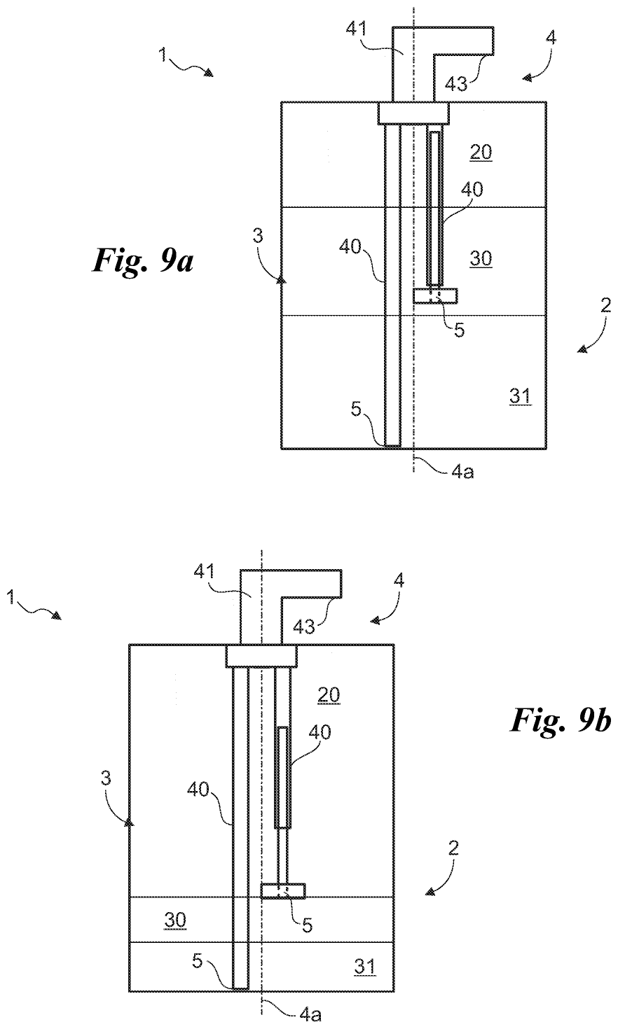

the FIG. 9a shows a simplified diagram of a dispensing device for multiphase liquids according to the invention in a sixth alternative embodiment wherein the cannulas are separated and one of the two cannulas is telescopic and includes a piston, provided with a float, in a configuration wherein it is immersed in the first component; and

the FIG. 9b illustrates a simplified diagram of the dispensing device for multiphase liquids of FIG. 9a wherein the first component is dropped to below a predetermined level and the piston of the telescopic cannula followed, thanks to the float, the first component.

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices.

The measurements and data reported in this text are to be considered, unless otherwise indicated, as performed in the International Standard Atmosphere ICAO (ISO 2533:1975).

With reference to the drawings, the dispensing device for multiphase liquids according to the invention is globally indicated with the number 1.

The device 1 is preferably configured to house at least one multiphase liquid 3. In this regard, the device 1 comprises at least one casing 2.

The casing 2 is substantially a container, of any shape, configured to allow the housing of at least one liquid inside it. Furthermore, preferably, the casing 2 is closed, or rather not accessible from the outside.

In particular, the casing 2 defines at least one chamber 20.

The chamber 20 is substantially a space or housing inside which the multiphase liquid 3, preferably in the liquid state, can be arranged. Naturally, the casing 2 could comprise a plurality of chambers 20, for example each including its own multiphase liquid 3 different from the others. However, in a preferred embodiment, the casing 2 comprises only a chamber 20.

The multiphase liquid 3 is therefore preferably housed in the chamber 20. The multiphase liquid 3 can be of the food type, or of another type. Preferably, the multiphase liquid 3 is of the cosmetic type. Even more in detail, multiphase liquid 3 is a bubble bath.

As such, the multiphase liquid 3 preferably comprises at least a first component 30 and a second component 31. In this case, essentially, the multiphase liquid 3 is a biphasic liquid.

Of course, the multiphase liquid 3 could include other additional phasic components. In any case, the first component 30 and the second component 31 are preferably both housed in the chamber 20. They are preferably any substances, preferably in the liquid state, of different density.

Furthermore, the first component 30 and the second component 31 are mutually immiscible. Therefore, the phasic components 30, 31 form, at least when the multiphase liquid 3 is at rest or decanted, an interface surface 32.

The interface surface 32 substantially delimits, inside the chamber 20, the first component 30 and the second component 31.

The interface surface 32 is, therefore, an abstract barrier determined by the separation, due to the immiscibility and the different density, of the phasic components 30, 31.

The device 1 therefore comprises a dispenser 4.

The dispenser 4 can be substantially mostly similar to the common dispensers that can be found on the market. An example of a dispenser suitable for the device 1 can be any conventional dispenser present in intimate detergents.

The dispenser 4 is preferably a pump dispenser, per se known to those skilled in the art. The term pump dispenser means that the dispenser itself comprises a pump, preferably manually activated and preferably arranged in correspondence with the dispenser 4. Said pump is activated by pressing the dispenser 4 and creates a depression in a chamber which activates the suction of fluid from inside the chamber. The dispenser 4 is preferably a pump dispenser configured to deliver liquid product and is for example quite similar to liquid soap dispensers, in particular it comprises a nozzle with a diameter greater than one millimetre. Alternatively, the dispenser 4 is a pump dispenser capable of emitting nebulized product and preferably comprises a nebulizer nozzle.

Again alternatively, the dispenser 4 is not a pump dispenser but a spray or aerosol dispenser and the casing 2 is made of pressure. In this case, the nozzle is preferably a nebulizer nozzle or, alternatively, a nozzle for dispensing liquid.

In general, the dispenser 4 therefore comprises one or more cannulas 40 and an expulsion mechanism 41.

The expulsion mechanism 41 is preferably arranged on the top of the casing 2. In particular, the expulsion mechanism 41 is arranged on the top of the casing 2 relative to the ground at least when the device 1 is in use.

With the term “in use” it is intended a conventional situation in which the device 1 is oriented correctly, with the casing 2 resting on a surface and the dispenser 4 accessible from above, with respect to the ground. This configuration is useful for describing the orientation of the various elements of the device 1, however it is not necessarily the only condition of use and therefore does not limit the device 1 to the only condition of use considered for the description.

The expulsion mechanism 41 is, therefore, operatively connected to the cannula 40 and is configured to pump the multiphase liquid 3 from the chamber 20 to the outside.

A mechanism of this type may include and/or be determined by a common push button as present in most of the known dispensers for intimate cleanser.

The cannula 40 or the cannulas 40 are substantially the dispenser portion 4 configured to be immersed in whole or in part in the multiphase liquid 3.

The one or more cannulas 40, therefore, define a first extension direction 4a. The first extension direction 4a is the direction along which the cannula 40 extends at least in part. In particular, the direction of extension 4a is skewed with respect to the ground, when the device 1 is in use in such a way as to access the multiphase liquid 3.

In particular, the cannula 40 preferably includes at least the first part 400. The first part 400 is substantially a part or portion of cannula 40, or is itself an entire cannula 40.

The first part 400 preferably extends at least partially along the first extension direction 4a.

The first extension direction 4a is substantially the direction along which the first part 400 mainly extends. Naturally, the first part 400 is substantially constituted by a tubular element which defines a lateral surface extending along the extension direction 4a and around it.

The first part 400, in particular, extends at least partially along the extension direction 4a within the chamber 20. The direction of extension 4a is, as already mentioned, preferably skewed with respect to the ground when the device 1 is in use.

Even more preferably, the extension direction 4a is perpendicular to the ground when the device 1 is in use and, suitably, the first part 400 extends from the expulsion mechanism 41 to the bottom of the casing 2.

The dispenser 4 may further include, a spout 43.

The spout 43 is operatively connected to the expulsion mechanism 41 and in fluid passage connection with the cannula 40.

In particular, preferably, the spout 43 is configured to mix the first component 30 and the second component 31 during the expulsion of the multiphase liquid 3 from the casing 2.

The dispenser 4 advantageously comprises some peculiar characteristics.

In fact, in general, the cannula 40 or the cannulas 40 globally comprise a plurality of first accesses 5.

With the term globally it is intended that, if only one cannula 40 is present, it comprises a plurality of first accesses 5, if more cannulas 40 are present, each cannula 40 could include only one respective access 5.

The first accesses 5 are substantially of the slots arranged on the lateral surface of the one or more cannulas 40. These slots can substantially be holes suitable for allowing the aspiration of multiphase liquid 3 from the chamber 20.

Advantageously, the first accesses 5 are arranged on planes spaced along the first extension direction 4a.

Even more suitably, the first access 5 are arranged in such a manner that at least two of the first accesses 5 are separated from the interface surface 32. In this way, the pump 41 of the first component simultaneously expulsion mechanism 30 and the second component 31.

In in particular, the first part 400 can comprise the plurality of first accesses 5. The first accesses 5 are substantially slits arranged on the lateral surface, in this case, of the first part 400.

Even more in detail, the first accesses 5 are distributed along the first extension direction 4a on the lateral surface of the first part 400.

The first accesses 5 are, therefore, mutually spaced apart in such a way that at least two of the first accesses 5 are separated from the interface surface 32.

In this way, when the expulsion mechanism 41 is operated, it simultaneously pumps the first phasic component 30 and the second phasic component 31.

In the first form of the embodiment, shown in FIG. 1, the device 1 comprises a cannula 40 mainly defined by the first part 400 only.

However, the device 1 can be made according to various different embodiments. In a second embodiment, the cannula 40 can comprise a connection part 402. The connection part 402, if present, is preferably a cannula portion 40 substantially without first accesses 5.

Therefore, the connection part 402 is simply a tubular element configured to connect the expulsion mechanism 41 and the first part 400. Even more in detail, the connecting part 402 places the first part 400 and the spout 43 in fluid passage connection, if the latter is present.

The connection part 402 can substantially be part of a straight cannula, not shown in the figures, which defines the connection part 402 in the portion adjacent to the expulsion mechanism 41 and a first part 400 towards the bottom of the chamber 20. Preferably, in a second embodiment, the connecting part 402 is configured in such a way that the free end of the first part 401 faces away from the ground, when the device 1 is in use.

In this way, the cannula 40 globally defines a U-shaped configuration.

In this particular configuration, advantageously, when the multiphase liquid 3 is pumped, and the liquid level drops inside the casing 2, the expulsion mechanism 41 does not direct access to the first accesses 5 not wetted by the multiphase liquid and, therefore, the possibility of pumping unwanted air is also reduced or avoided, as instead can occur with the first embodiment.

In a third embodiment, the cannula 40 can also define a second part 401. The second part 401, if present, is similar to the first part 400. The second part 401 is also preferably in fluid passage connection with the first part 400 and, similarly to the connecting part 402 of the second embodiment, extends alongside of the first section along a second extension direction 4b.

Basically, as shown in FIG. 3, in the third embodiment the first part 400 places the second part 401 and the expulsion mechanism 41 in fluid passage connection similarly to how it occurs in the second embodiment thanks to the connecting part 402.

The second extension direction 4b is determined by the direction along which the second part 401 mainly extends.

The second part 401, therefore, is configured in such a way that the free end faces and faces away from the ground, when the device 1 is in use.

Also in this case, the cannula 40 globally defines a U-shaped configuration. The second part 401 preferably includes second accesses 6.

The second accesses 6 can be similar or even identical to the first accesses 5. They can be of the same or different dimensions, for example larger than the first accesses 5.

Therefore, the second accesses 6 can also consist of slots and/or holes. The second accesses 6 are preferably distributed along the second extension direction 4b on the lateral surface of the second part 401.

Furthermore, also the second accesses 6 can be mutually spaced in such a way that at least two of them are separated from said interface surface 32.

Alternatively, the second accesses 6 could be configured to be not separated from the interface surface 32, as in FIG. 6, but able to access only one of the components 30, 31.

In general, both the first accesses 5 and the second accesses 6 can be constituted by holes distributed in such a way as to be mutually equidistant respectively along the first direction of extension 4a and the second direction of extension 4b. Preferably, in the embodiments described above, the one or more cannulas 40 are rigid and maintain the same shape regardless of the multiphase liquid 3, that is, from the level of multiphase liquid 3 inside the casing 2.

In other alternative forms, however, at least one cannula 40 can also be at least partially deformable. By deformable it is meant that the cannula 40 can be moved by the multiphase liquid 3 as described below.

In a second alternative embodiment and in a third alternative embodiment, in fact, the cannula 40 could include a float 42.

The float 42 is an element, preferably having a density lower than the phasic components 30, 31 and configured to float on the free surface of the multiphase fluid 3.

The float 42 is arranged at a free end of the cannula 40 and configured to maintain the extreme free positioned at the free surface of the multiphase fluid 3. In particular, in the second alternative embodiment shown in FIG. 4, the float 42 is arranged at the free end of the first part 400 and configured to keep the free end positioned at the free surface of the multiphase fluid 3.

In the third alternative embodiment shown in FIG. 5, the float 42 is arranged at the free end of the second part 401 and configured to keep the free end positioned at the free surface of the multiphase fluid 3.

Preferably, moreover, in the second embodiment and preferably the first part 400 is made of deformable material, in the second alternative embodiment, at least the second part 401 is made of deformable material.

In general, at least part of the cannula 40 is deformable and changes its shape depending on the level of said multiphase liquid 3 within the casing 2. In other words, the deformable cannula portion 40 follows the multiphase fluid included in the casing 2.

The device 1 can also give rise to embodiments which combine the teachings of the previous ones.

For example, in a fourth embodiment, the dispenser 4 can comprise a plurality of cannulas 40.

These cannulas 40 can be mutually separated. Or, as shown in FIG. 6, they can share at least one portion. In other words, the cannulas 40 can be at least partially superimposed and can also be defined as a single cannula 40 which bifurcates. In the fourth embodiment, in particular, preferably at least two of the cannulas 40 share at least part of a connection part 402.

Furthermore, one of the two cannulas can be of the type described for the first embodiment, and substantially have the connection part 402 and a first part 400 facing the bottom of the chamber 20 or, better said, towards the ground when the device 1 is in use.

The other cannula can be of the type described for the third embodiment and comprises the connection part 402 and a first part 400 whose free end is turned away from the bottom of the chamber 20 and is constrained to the float 42. At the same way, in a fourth alternative embodiment, preferably at least two of the cannulas 40 share at least part of a first part 400.

In this case, one of the two cannulas can be of the type described for the first embodiment, and substantially have only the first part 400, as shown in FIG. 1, directed by the expulsion mechanism 41 towards the bottom of the chamber 20 or, better said, towards the ground when the device 1 is in use.

The other cannula can be of the type described for the third alternative embodiment and comprises the first part 400 and a second part 401, the free end of which faces away from the bottom of the chamber 20 and is constrained to the float 42.

In a fifth embodiment, simplified and therefore very advantageous, the dispenser 4 can include two cannulas 40 which share a connection part 402 and which include a first part 400 facing the bottom of the chamber 20 and a first section with floats 42. Or, in other words, the cannula 40 can bifurcate into two first parts 400. As shown in FIG. 8, each of the first parts 400 can therefore include a first access 5 at their respective ends. A first access 5 is therefore, in this configuration, facing the bottom of the chamber 20 and accesses the second component 31. Another access 5 is always arranged substantially on the free surface of the multiphase liquid 3 and accesses the first component.

In this way, the only two first accesses of the cannula 40 remain arranged on planes spaced apart along the extension direction 4a and are separated from the interface surface 32 so as to allow the components 30, 31 to be pumped simultaneously. In a sixth embodiment, shown in FIGS. 9a-9b, the dispenser 4 can even include two separate cannulas 40. Such cannulas 40 can comprise a respective first access 5. One of the two cannulas 40 can be telescopic and therefore include a piston at the end of which the float 42 is connected and configured to always be in communication with the first component 30.

In this regard, as shown, the piston can have a predetermined stroke along the extension direction 4a in such a way as to be immersed when the first component 30 is above a predetermined level, and to move following the first component 30 when the latter descends below the predetermined level.

These phases are clearly highlighted and described in the aforementioned figures. The operation of the multiphase liquid dispensing device 1 previously described in structural terms is as follows.

Basically, when a user presses the expulsion mechanism 41, the cannula 40 allows to pump both the phasic components 30, 31 from the chamber 40 in relation to the quantity of accesses 5, 6 wetted by the components, i.e. in proportion to the quantity of components 30, 31 introduced into the chamber 20.

The two components 30, 31 are then mixed at the outlet also thanks to the presence of a possible spout 43.

The dispensing device for multiphase liquids 1 according to the invention achieves important advantages.

In fact, the device 1 is simpler and less complex structurally than the devices of the known art. It includes a casing with a single chamber 20 and a dispenser, made ad hoc, which allows to obtain great efficiency without additional costs compared to common bottles.

Furthermore, a further advantage is given by the fact that the multiphase liquid dispensing device allows to carry out the mixing of the phase components, moreover with great efficiency, without resorting to manual mixing by a user.

In conclusion, a further advantage is given by the fact that the liquid dispensed by the device 1 is excellent and is mixed with great efficiency since, especially the second embodiment, it allows to avoid unwanted foaming deriving from the excessive pumping of air, simultaneously with the multiphase liquid 3, to the spout 43 or in any case to the outlet of the dispenser 4.

The invention is susceptible of variants falling within the scope of the inventive concept defined by the claims. For example, to limit the effects deriving from the air, the first accesses 5 arranged in proximity to the expulsion mechanism 41 can be smaller than the first and/or second accesses 5, 6 arranged in more spaced positions with respect to the expulsion mechanism 41.

In this context, all the details can be replaced by equivalent elements and the materials, shapes and dimensions can be any.

1. A dispensing device for multiphase liquids comprising:
a closed casing defining at least one chamber configured to contain one or more substances,
a multiphase liquid including at least:
a first component housed within said chamber, and
a second component housed within said chamber, of different and immiscible density with respect to said first component so as to form, at least when said multiphase liquid is at rest, an interface surface which delimits said components,
a dispenser including:
one or more cannulas defining a first direction of extension skewed with respect to the ground when said device is in use to access said multiphase liquid, and
an expulsion mechanism arranged on the top of said casing with respect to the ground at least when said device is in use, operatively connected to said cannula and configured to pump said multiphase liquid from said chamber outwards,
wherein said one or more cannulas comprise globally a plurality of first accesses arranged on planes spaced along said first extension direction in such that at least two of said first accesses are separated from said interface surface and said expulsion mechanism simultaneously pumps said first component and said second component.

2. The device according to claim 1, wherein a cannula comprising at least a first part extending within said chamber, at least partially along a first extension direction skewed relative to the ground when said device is in use in such a way as to access said multiphase liquid and said first section comprises a plurality of first accesses distributed along said first extension direction on a surface side of said first part and mutually spaced so that at least two of said first accesses are separated from said interface surface and said expulsion mechanism simultaneously pumps said first component and said second component.

3. The device according to claim 1, wherein said cannula comprises a connection part configured to put in fluid passage connecting said expulsion mechanism and said first part, abreast to said first part and configured in such a way that a free end of said first part faces away from said ground, when said device is in use, and that said cannula defines globally a U-shaped configuration, said connecting section being devoid of said first accesses.

4. The device according to claim 1, wherein said cannula defines a second part in fluid passage communication with said first part and extending to the left of said first part along a second extension direction in such a way that a free end of said second part faces away from said ground, when said device is in use, and that said cannula globally defines a U-shaped configuration, said second part including second accesses distributed along said second extension direction on a lateral surface of said second part and mutually spaced in such a way that at least two of said second accesses are separated from said interface surface.

5. The device according to claim 1, wherein at least one said cannula comprises a float arranged in correspondence with a free end of said cannula and configured to maintain said free end positioned in correspondence of the free surface of said multiphase fluid.

6. The device according to claim 1, wherein said dispenser comprises a plurality of said cannula and at least two of said cannula share at least part of said connection portion or part of said first section.

7. The device according to claim 1, wherein said cannula is rigid and maintains the same shape independently of said multiphase liquid.

8. The device according to claim 1, wherein at least part of said cannula is deformable and changes its form in dependence upon the level of said multiphase liquid within said casing.

9. The device according to claim 1, wherein said first access and said second access are constituted by holes distributed in such a way as to be mutually equidistant along respectively said first extension direction and said second extension direction.

10. The device according to claim 1, wherein said dispenser comprises a spout operatively connected to said expulsion mechanism, in fluid passage connection with said cannula and configured to mix said first component and said second component during the expulsion of said multiphase liquid from said casing.

11. The device according to claim 4, comprising two of said separate cannula and one of said cannula is telescopic and includes a piston whose end is connected to said float and having a predetermined stroke along said extension direction in such a way as to be submerged as long as said first component is above a predetermined level, and to move following said first component when said first component falls below said predetermined level.

12. The device according to claim 1, wherein said dispenser is a pump dispenser.

13. The device according to claim 12, wherein said dispenser is configured to dispense the liquid product.

14. The device according to claim 12, wherein said dispenser is configured to deliver nebulized product.

15. The device according to claim 2, wherein said cannula defines a second part in fluid passage communication with said first part and extending to the left of said first part along a second extension direction in such a way that a free end of said second part faces away from said ground, when said device is in use, and that said cannula globally defines a U-shaped configuration, said second part including second accesses distributed along said second extension direction on a lateral surface of said second part and mutually spaced in such a way that at least two of said second accesses are separated from said interface surface.
